(19) United States
(12) Patent Application Publication
(10) Pub. No.: US 2020/0278994 A1
(43) Pub. Date: Sep. 3, 2020

(54) SYSTEM FOR CONTENT ARCHIVING AND MANAGEMENT WITH CODE READERS

(71) Applicant: AUGUZ LIMITED, Hong Kong (HK)

(72) Inventors: Shing Yau FUNG, Hong Kong (HK); Yat Chiu NG, Hong Kong (HK); Wai Yee TANG, Hong Kong (HK)

(21) Appl. No.: 16/647,875

(22) PCT Filed: Sep. 17, 2018
(86) PCT No.: PCT/IB2018/057093

§ 371 Date: Mar. 17, 2020

(30) Foreign Application Priority Data
Sep. 18, 2017 (HK) 17109434.6

(51) Int. Cl. G06F 16/435; G06F 21/34; G06T 19/00; G06F 16/438

(52) U.S. Cl. CPC G06F 16/437; G06F 16/438; G06T 19/006; G06F 21/34

(57) ABSTRACT

The present invention relates to a system for content archiving and management with code readers. The system comprises a combination code comprising a number of code elements, said combination code having a plurality of combinations and capable of interacting with trigger conditions; a code reader for detecting said combination code and trigger conditions upon activation; a content database communicably linked to said code reader, wherein said content database is divided into a plurality of partitions based on different combinations of said combination code and an identity and a privilege order of a user; an output device communicably linked to said code reader and said content database; wherein said output device retrieves and outputs content stored in a corresponding partition of said content database upon said code reader detecting a combination of said combination code.

### FIELD OF INVENTION

The present invention relates to the field of content archiving and management, in particular a system for content sharing, collaborating, archiving and management with code readers, which aims to enrich human bonds, facilitate knowledge building, advocate creativity, and regain privacy control back to users' own hands.

### BACKGROUND OF INVENTION

We live in the age overwhelmed with all sorts of data and information. Coupled with ever advancing technology in the field of content sharing, either through social media or peer to peer sharing, which leads to overflooding the users with excessive information every moment of the day. On individual level, however, this mode of information overflow spreading on veneer thin level does not enrich but instead diluting human bonds. In fact, when scanning through the vast ocean of shared information, only a tiny portion is actually valuable to the user, may that be related to one's memorable experience in life, or in cultivating bonds with close friends and dear ones. When come to the academic knowledge level, in both arts and science fields, the present mode also failed in providing a systematic framework for consolidating one's expertise or broadening one's knowledge base, let alone cultivate creativity. As such, within one's limited life span, a system which can be tailored enabling the users to navigate, prioritize and process information, knowledge and ideas will be of substantial benefits to users. From another perspective, there are also other deficiencies in the field of content archiving and management. Minor ones are such as access to the saved content is not straightforward, information across the board were not on the same page, or when information was altered without the appropriate authority order. Major ones are on security and privacy control, such as when content shared around or distributed on public domain beyond the user's willful control or without prior consent. Therefore, a system for content archiving and management is devised in the present invention that aims to enrich human bonds, to provide a cohesive interaction platform for multiple users to distill information, facilitate knowledge building, cultivate creativity within a single or across multiple partitions, and to regain privacy control back to the users' own hands.

### SUMMARY OF INVENTION

In light of the foregoing background, a system for content sharing, collaborating, archiving and management with code readers is provided. The system of the present invention allows a user to assign content to a partition in a content database, which can only be accessed when an authenticated code reader detects a specific combination of the combination code and an associated privilege order. The content is then output through an output device for the user to view, edit or contribute with other ideas.

In one embodiment, the system comprises a combination code comprising a number of code elements, said combination code having a plurality of combinations; a code reader for detecting said combination code; a content database communicably linked to said code reader, wherein said content database is divided into a plurality of partitions based on different combinations of said combination code and an identity and said privilege order (including information class) of a user; an output device communicably linked to said code reader and said content database; wherein said output device retrieves and outputs content stored in a corresponding partition of said content database upon said code reader detecting a combination of said combination code.

In a preferred embodiment, each of said plurality of partitions is shareable and collaborated with other users. In a further embodiment, each user has a determined combination code for accessing a shared partition according to the respective privilege order.

In a preferred embodiment, said code reader comprises an authentication module for confirming said identity and said privilege order of said user.

In a preferred embodiment, said content stored in said content database is multimedia content. In another embodiment, said output device outputs said multimedia content by augmented reality.

The system of the present invention allows a user to distill, sort and archive specific content into different partitions with a different combination of combination code for accessing. Each partition can be shared in layers or segments with other users with different privilege order(s), and only such users can access the content in the shared partition, thus ensuring privacy and security of information authorized. The combination code can be provided through a wearable device for ease of access and collaboration.

### BRIEF DESCRIPTION OF DRAWINGS

The present invention is further explained below with the accompanying drawings and embodiments.

FIG. 1 is a block diagram of a system for content sharing, collaborating, archiving and management with code readers of the present invention.

FIG. 2 is a block diagram of a code reader of a system for content sharing, collaborating, archiving and management with code readers according to an embodiment of the present invention.

FIG. 3 is a block diagram of a system for content sharing, collaborating, archiving and management with code readers of the present invention with sharing of content.

### DETAILED DESCRIPTION OF INVENTION

The present invention is further explained below along with the accompanying drawings. The drawings only illustrate the structures or steps that are relevant to the present invention, it is obvious that one skilled in the art will understand that modifications or variations, or deepening or expansions, can be made without departing from the scope of the invention to achieve any expected functions as desired.

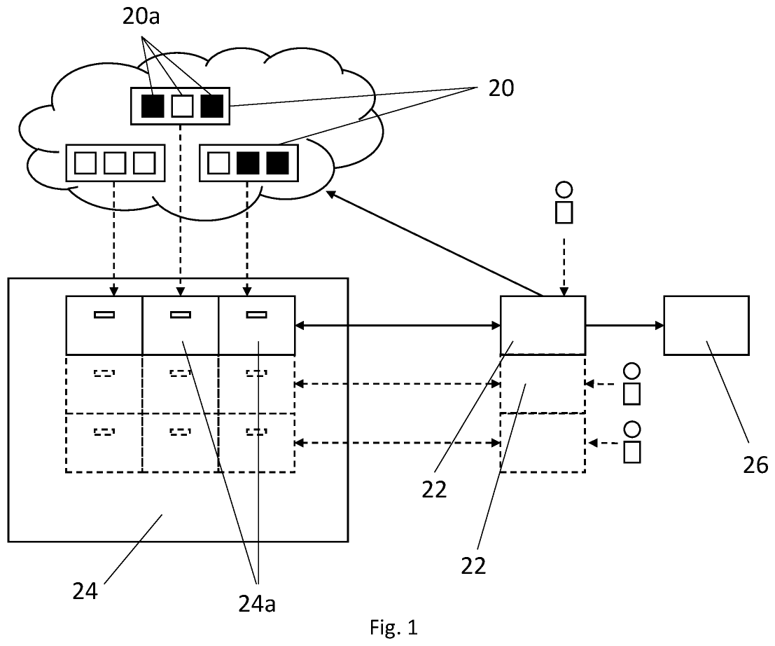

A first embodiment of a system for content managing with code readers is shown in FIG. 1. The system comprises a combination code 20 having a plurality of code elements, a code reader 22 for detecting the combination code 20, a content database 24 communicably linked to the code reader 22, and an output device 26 communicably linked to the code reader 22 and the content database 24.

The plurality of code elements of the combination code 20 allows the combination code 20 to have a plurality of possible combinations. In the embodiment as shown in FIG. 1, there are three code elements in the combination code 20, and each code element can have multiple configurations including white and black. It is obvious that each code element can possess any number of configurations, and different numbers of configurations are possible across different code elements in a combination code 20. Each code element can vary in shape, size, color etc. for determining the number of possible combinations. Some example code elements are alphanumerals, signs, numbers or characters, items or accessory, or a landmark at a specific location etc., or a combination of the above. The code elements can also be in a certain combination of space and time criteria or spatiotemporal interval when forming the combination code 20.

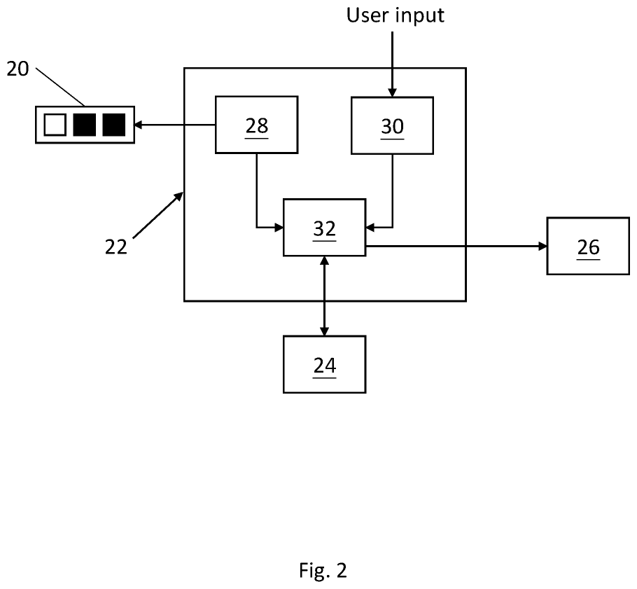

In an exemplary embodiment as shown in FIG. 2, the code reader 22 comprises a detection module 28 such as a camera for detecting the combination code 20. The code reader 22 also comprises an authentication module 30 that receives user input and confirms the identity and privilege order of the user, and the authentication module 30 can adopt traditional password or biometric information such as fingerprint or other methods for authentication. A communication module 32 is connected to the detection module 28 for communicating with the content database 24 and the output device 26. In an exemplary embodiment, the code reader 22 is a mobile phone. The code reader 22 can also be a smart watch or other wearable devices with detecting and scanning capabilities and a user interface.

Referring back to FIG. 1, the content database 24 is divided into a plurality of partitions 24a. Each partition 24a corresponds to a combination of the combination code 20 for an authenticated user, hereinafter referred to as “user”. In the figure, each row of partitions 24a corresponds to one user, and different rows means there are different distinct users, the users can be further segmented by their privilege orders. It is also possible that a user possesses multiple code readers 22, in that case all code readers 22 belonging to a same user shall share the same row of partitions 24a. The number of partitions 24a available to a user shall be equal to the number of possible combinations for the combination code 20. It is possible that different users may have different number of partitions 24a available, sortable, editable or accessible based on the privilege order. In a preferred embodiment, the content stored in the content database is limited to multimedia content with specific formats that are supported by the output device 26 to ensure that the output device 26 can readily output the content when instruction is received.

When the code reader 22 detects the combination code 20, the code reader 22 sends a signal to the output device 26 and/or the content database 24. The signal includes the combination being detected by the code reader 22 and the identity and privilege order of the user as authenticated by the code reader 22. The output device 26 then retrieves the content from the corresponding partition of the content database 24, either directly or through the code reader 22, and either editable or not editable. The retrieved or edited content is then output to the user with associated privilege order for viewing, editing and combining.

In various embodiments, the video data of the multimedia content is output by augmented reality or by projection onto a flat or contoured surface, or projected into the air. Augmented reality is shown on a display screen and overlays the multimedia content on background data such as a live camera view, providing a more realistic virtual reality experience to users. On the other hand, projection allows the content to be shown in a larger area and also allows a group of users to view or edit the content in collaboration at the same time. In an exemplary embodiment, the output device 26 is a display of a mobile phone or a projector connected to a mobile phone. The output device 26 can also be the same device as the code reader 22.

In a preferred embodiment, detection of the combination code 20 by the code reader 22 is further controlled by conditional triggers. For example, the code reader 22 is only activated for detection when certain conditions are fulfilled, such as at a certain time of the day, or having another code reader 22 in proximity. Alternately, the code reader 22 is activated for detection at all times but communication with content database 24 and output device 26 is only initiated when the conditions are fulfilled, which could be establishing an internet connection with a specific known network, the code reader 22 moving from one location to another, or after a certain time delay etc.

In a preferred embodiment, the content output by the output device 26 is further customized through display rendering settings. For example, the output device 26 can output the content with a different background when the combination code 20 is detected at day time or night time, or at specific hours or a specific day of the year such as a birthday or a specific combination of time period and location or condition. The background can also dependent on an environmental climate or temperature, a location of the code reader 22, or conditions that relate to other code readers 22 such as a distance between other code readers 22. Other parameters can also be changed, such as contrast of display, the combination of space and time criteria or spatiotemporal interval, the ratio between virtual and reality, or a depth of view if a three-dimensional display is employed. The display rendering settings can be stored locally in the code reader 22 or the output device 26, or stored in a server and retrieved and/or edited every time with the content in the content database 24.

In one embodiment, a known number of combinations for the combination code 20 is provided to the user through a holder device. The holder device allows a user to set a combination code from a predetermined number of selected code elements. The holder device is preferably portable such that the user can access, edit, collaborate, or combine the desired content at any time.

In an alternate embodiment, the content stored in the content database 24 is an encrypted content file instead of multimedia clip. The entire protected file is only able to be accessed or edited when a group of code readers 22 are within a predetermined setting or space and time interval, and all code readers 22 detects the combination code 20 at the same time or within a predetermined period of space and time interval. The output device 26 retrieves the file from the content database 24 and may further allow editing or other actions. Each code reader 22 can be set to access a part of the file, and the part can be either readable as if a word file is separated into a few segments, and/or not readable through an encryption algorithm that is only meaningful when all parts are combined like pieces of a puzzle.

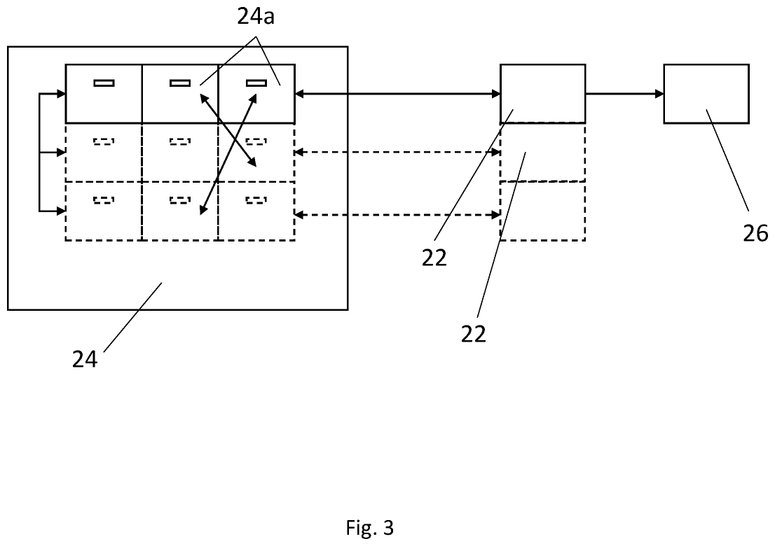

In a preferred embodiment as shown in FIG. 3, content stored in a partition 24a can be shared between a group of users. Each user may share a same authorization combination or have a different combination linked to the shared partition 24a, and the content can be shared to any number of users. In a preferred embodiment, a user interface is provided at the code reader 22, the output device 26 or at another terminal to allow the user to manage the partitions 24a, such as sorting and assigning content to the partition 24a, sharing a partition 24a to other users, or configuring display rendering settings and setting conditional triggers.

An example process flow of using the present system is explained below. First, a user registers to a service provider platform thereby allowing the code reader to authenticate the user. The registered user can then upload and assign specific content to different combinations of a combination code through the user interface. Once the content is assigned, the user can then send invites to a group of users and gives the group of users a privilege order (including information class) for sharing the content stored inside a partition. The other users in the group by accepting the request gains access to the partition depending on the privilege order, and each user can assign a combination of his choice for the partition. Users that are not invited cannot access the partition even if they know the combination, therefore the content is highly secure. In the event of a certain partition(s) being mishandled, the subject partition will be automatically sealed off, followed by notifying the users with relevant privilege order for necessary follow-up actions. Other users in the group may be granted the right to view, edit or collaborate on the content as well based on the privilege order, such as appending another video clip to the current video clip, or customizing display settings regarding to condition triggers. The platform may provide a method to merge multiple clips together or play the content files in order. In addition to the code reader itself, the above flow may also be performed using a PC or other devices that does not have a scanning device, provided that the device can communicate with the service provider.

The preferred embodiments of the present invention are hereby disclosed. The preferred embodiments only explain the present invention by way of example, but not limitation. It is obvious that a person skilled in the art can make various modifications and adjustments, or deepening or enhancement, to the details without departing from the spirit and concept of the present invention. The scope of the present invention is not limited to the specification but is defined by the scope of the claims.

What is claimed is:

1. A system comprising:
a combination code comprising a number of code elements, said combination code having a plurality of combinations, said combination code can operate in isolation or upon activation in association with trigger conditions; each code element can vary in shape, size, color etc. for determining the number of possible combinations; said code element include alphanumerals, signs, numbers or characters, items or accessory, or a landmark at a specific location etc, or a combination of the above; said code elements can be in a spatial and/or temporal sequence or both when forming said combination code;
a code reader for detecting said combination code, said code reader being a mobile device comprising a camera for detecting said combination code, said code reader comprising an authentication module for authenticating an identity and a privilege order of a user;
a content database communicably linked to said code reader, wherein said content database is divided into a plurality of partitions based on different combinations of said combination code, an identity, privilege order including information class of said user; each said partition can be shared or coordinated to other invited users based on said privilege order of said user;
an output device communicably linked to said code reader and said content database; said output device being a display screen of said mobile device or a projector;
wherein said output device retrieves and outputs content stored in a partition of said content database upon said code reader authenticates said identity of said user and detecting a corresponding combination of said combination code and said privilege order of said user; said user after registration can upload and assign content of a specific partition to different combinations of said combination code through a user interface; then said user sends an invitation and assign said privilege order to a group of users to share content of said specific partition; said group of users can only access or edit content of said shared partition in his code reader after accepting said invitation, users not invited, not possessing the authenticated code readers, or does not have the corresponding privilege order are unable to access, collaborate or share said partition even if said users know the combination code.

3. The system according to claim 1, wherein each user can form a determined combination code for accessing a shared partition.

6. The system according to claim 1, wherein said content stored in said content database is multimedia content.

7. The system according to claim 1, wherein said content stored in said content database is an encrypted content file; the protected encrypted content file can only be accessed or edited if a group of code readers detect said combination code within a certain combination of space and time criteria or spatiotemporal interval.

8. The system according to claim 1, wherein said output device outputs said content by augmented reality.

9. The system according to claim 1, wherein said output device outputs said content depending on display rendering settings.

10. The system according to claim 1, wherein said code reader detects said combination code based on conditional triggers.
